(19) United States
(12) Patent Application Publication
(10) Pub. No.: US 2023/0182210 A1
(43) Pub. Date: Jun. 15, 2023

(54) METHOD FOR ADDITIVE MANUFACTURING BY MEANS OF DUAL SELECTIVE IRRADIATION OF A POWDER BED AND PREHEATING

(71) Applicant: Siemens Energy Global GmbH & Co. KG, Munich, Bayern (DE)

(72) Inventors: Christoph Haberland, Bochum (DE); Michael Ott, Mülheim an der Ruhr (DE)

(73) Assignee: Siemens Energy Global GmbH & Co. KG, Munich, Bayern (DE)

(21) Appl. No.: 17/923,589

(22) PCT Filed: May 3, 2021
(86) PCT No.: PCT/EP2021/061496

§ 371 Date: Nov. 6, 2022

(30) Foreign Application Priority Data
May 15, 2020 (DE) 10 2020 206 161.0

(51) Int. Cl. B22F 12/45; B22F 10/28; B22F 10/64; B22F 12/10; B22F 12/41; B33Y 30/00; B33Y 10/00; B33Y 40/20

(52) U.S. Cl. CPC B22F 12/45; B22F 10/28; B22F 10/64; B22F 12/10; B22F 12/41; B33Y 30/00; B33Y 10/00; B33Y 40/20

(57) ABSTRACT

A method and device for powder bed additive manufacturing of a component includes the selective irradiation of a layer made of a powder material with a first energy beam and a second energy beam, that is different from the first, wherein the second energy beam annularly surrounds the first energy beam, and the aselective heating of the layer, wherein a large part of the layer is heated to a temperature that is at least one quarter of the temperature that the layer is heated to as a result of the selective irradiation.

### CROSS REFERENCE TO RELATED APPLICATIONS

This application is the US National Stage of International Application No. PCT/EP2021/061496 filed 3 May 2021, and claims the benefit thereof. The International Application claims the benefit of German Application No. DE 10 2020 206 161.0 filed 15 May 2020. All of the applications are incorporated by reference herein in their entirety.

### FIELD OF INVENTION

The present invention relates to a method for powder bed-based additive manufacturing of a component by dual selective irradiation and integrated preheating, and to a corresponding apparatus.

The components mentioned are preferably provided for use in a turbomachine, preferably in the hot gas path of a stationary gas turbine. The component preferably consists of a superalloy, in particular a nickel- or cobalt-based superalloy. Alternatively, the corresponding component can be some other component, such as for example, a high-performance component for applications in aeronautics or in automobility.

### BACKGROUND OF INVENTION

Additive manufacturing methods include as powder bed methods, for example, selective laser melting (SLM) or laser sintering (SLS), or electron beam melting (EBM). Further additive methods are for example “Directed Energy Deposition (DED)” methods, in particular laser deposition welding, electron beam welding, or plasma powder welding, wire welding, metallic powder injection molding, so-called “sheet lamination” methods, or thermal spraying methods (VPS LPPS, GDCS).

Owing to its disruptive potential for industry, generative or additive manufacturing is becoming increasingly of interest also for the series production of the abovementioned turbine components, such as, for example, turbine blades or burner components.

Modern gas turbines are the subject of continuous improvement in order to increase their efficiency. However, this leads, inter alia, to ever higher temperatures in the hot gas path. The metallic materials for rotor blades, particularly in the first stages, are continuously being improved with regard to their strength at high temperatures, creep loading and thermomechanical fatigue.

Additive manufacturing methods have proved to be particularly advantageous for components that are complex or of a filigree design, for example labyrinthine structures, cooling structures and/or lightweight structures. In particular, additive manufacturing is advantageous as a result of a particularly short chain of process steps, since a step for the manufacture or production of a component can be performed largely on the basis of a corresponding CAD file and the choice of corresponding production parameters. The manufacture of gas turbine blades by means of the described powder bed-based methods (PBF stands for “Powder Bed Fusion”) advantageously makes it possible to implement new geometries, concepts, solutions and/or design, which reduces the manufacturing costs or the construction and throughput time, optimizes the manufacturing process and may improve for example a thermomechanical design or durability of the components.

Blade components manufactured in a conventional manner, for example by casting, are significantly inferior to the additive manufacturing route for example with regard to their design freedom and also in regard to the required throughput time and the high costs associated therewith, and also the manufacturing complexity.

A method and an apparatus for the additive manufacturing of components are known from DE 10 2017 21 37 62 A1, for example, where a kind of dual or synchronous selective melting by means of different laser beams likewise takes place, but preheating as described on the basis of the present invention does not take place.

A similar principle of an optical irradiation unit for an installation for manufacturing workpieces by irradiating powder layers with laser radiation is known from EP 2 335 848 A1, for example.

A method and an apparatus for additive manufacturing with preheating are furthermore known from DE 10 2010 048 335 A1, but synchronous or dual selective irradiation is not employed in that case.

Furthermore, an apparatus for additive manufacturing with electron beam preheating, a laser solidifier and a corresponding method are known from DE 10 2015 201 637 A1, where use is made of an electron beam-based preheating, in particular, but that is used for avoiding hot or solidification cracks, rather than as described below, in association with the present invention.

The document DE 10 2014 204 580 A1 describes an apparatus which provides, at least above a component platform, a heating device for segment-by-segment heating of a surface of a powder layer to be solidified.

During the additive manufacturing of a component from a powder bed, i.e. by means of “powder bed fusion”, as is known, a preheating of the material to be processed is also effected by way of a heating of a build platform. Such preheating measures are inadequate, however, since such a platform heating normally only allows preheating temperatures of approximately 200° C., and thus cannot significantly contribute to the reduction of the inherent stresses. Depending on the material respectively used and the powder granulation, the heat conduction is inadequate, and so the preheating effect, in particular during the processing of nickel- or cobalt-based superalloys, decreases greatly as the construction height increases. Moreover, in the case of these alloys, the gamma phase (cf. “γ”) of which can form a high proportion of so-called (gamma prime) γ′ precipitates, an additional factor is that these are therefore deemed to be difficult to weld or not weldable at all, and thus have to be preheated at high temperature but still below the γ/γ′ solvus temperature (i.e. below the onset of the γ′ precipitation), in order to foster the welding suitability.

The abovementioned conventional concepts for preheating cannot achieve, or at any rate cannot reliability achieve, a required temperature level, of between 400° C. and 500° C., for example, across the entire build height of the component.

Even concepts which achieve temperatures of 1000° C. in the build space of a corresponding manufacturing installation by means of inductive heating have the disadvantage that, firstly, the surrounding powder is sintered to a great extent. In addition, an inadequate heat conduction occurs in this case, too, which has the effect that—starting from a certain component height—the preheating temperature is no longer sufficient to achieve the desired effect.

### SUMMARY OF INVENTION

It is therefore an object of the present invention to provide means for improved thermal management which solves the problems described above, in order in particular to enable the weldability of alloys which are nominally difficult to weld or scarcely weldable, and at the same time to achieve a significantly improved reduction of stress and/or a significantly reduced cracking tendency of the processed material.

This object is achieved by means of the subject matter of the independent patent claims. The dependent patent claims relate to advantageous embodiments.

One aspect of the present invention relates to a method for the powder bed-based additive manufacturing of a component, comprising the selective irradiation of a layer composed of a pulverulent material, whereby the component is built up layer by layer, preferably by selective laser sintering, selective laser melting or electron beam melting. The irradiation is effected by a first energy beam and a second energy beam, different from the first, wherein the second energy beam ring-shapedly surrounds the first energy beam. This ring-shaped arrangement should be understood such that either the entire second energy beam can ring-shapedly surround the first energy beam, or just a beam focus, for example on a corresponding manufacturing or powder surface of the corresponding layer.

The method furthermore comprises the aselective, non-selective, delocalized or global irradiation or heating of the layer, wherein a large portion, for example a majority or large part or the entire production surface, of the layer is heated to a temperature of at least one quarter of the temperature which the layer experiences as a result of the selective irradiation described. The latter temperature expediently corresponds to at least a melting point of the material for the construction of the component. In accordance with the principle of the PBF methods, the irradiation, sintering or the melting of the material is effected very locally for example at the beam focus and/or in a heat-affected zone.

In one embodiment, a large portion of the layer is heated by the aselective heating to a temperature of at least one third or even just below half of the temperature which the layer experiences as a result of the selective irradiation.

By means of the method described, in particular by means of the presented combined and targeted application of heat with the aselective heating of the layer, what is advantageously achieved, firstly, is a reduction of the inherent macro-stresses which are process-inherent and arise for virtually all materials. Furthermore, the local preheating as part of the selective irradiation makes it possible to process e.g. nickel-based superalloys which are difficult to weld, by virtue of the reduction of inherent micro-stresses through segregation effects or segregation. According to the most recent insights, cracks caused by such stresses crucially arise during the process owing to the fact that healing the cracks or feeding them through an existing melt (“backfeeding”) is still no longer possible.

In a subsequent heat treatment, a superposition of both inherent stresses generally results in a significant occurrence of cracks, in particular as a result of so-called “strain age cracking” or “post weld heat treatment cracking” in the case of the alloys or materials mentioned.

In such (subsequent) heat aftertreatments, in particular the actual precipitation for the hardening of the material can also take place. This is usually superposed with the reduction of stress, which would especially promote macrocracks without the means of the present invention.

A simultaneous reduction of inherent macro- and microstresses through the combination of a—as described—local and global preheating has a positive effect in particular on the avoidance of the cracking effects mentioned above. Furthermore, sintering effects are not expected owing to the still sufficiently low global preheating temperature. As a result, a considerable improvement of the surface quality and the surface resolution in comparison with conventional electron beam-based additive methods should partially be assumed as well.

In one embodiment, the first energy beam constitutes a melting laser or first laser, and the second energy beam constitutes a second, further laser beam, which preferably has a lower radiation intensity than the melting laser. This embodiment makes it possible to achieve selective irradiation with an advantageous heat input into the layer, in particular to reduce a temperature gradient which occurs in the layer.

In one embodiment, the further laser beam brings about a local heating, in particular preheating, of the layer to a temperature of above 400° C., preferably above 500° C. As a result of this embodiment, advantageously, in particular, a small material volume around the processing focus of the first laser or of the melting laser can be kept at an elevated temperature and thus excessively large temperature gradients can advantageously be avoided.

In one embodiment, the melting laser and/or the further laser or laser beam have/has a wavelength in the infrared range.

In one embodiment, the aselective heating is effected at a temperature of between 400° C. and 500° C. and/or between 50° C. and 100° C. below an initial temperature for the formation of phase precipitates, in particular for the formation or precipitation of the gamma prime phase of the material. In the case of the second alternative of this embodiment, the selective heating advantageously takes place far enough away from an onset temperature for the phase precipitation of the gamma prime phase. The aforementioned onset temperature or initial temperature may denote a temperature starting from which furthermore a coefficient of thermal expansion of the material is reduced in a temperature-dictated manner. As a result of this embodiment, the temperature to which a large portion of the layer is extensively heated is advantageously optimized and coordinated with the selective irradiation of the layer. The temperature mentioned is chosen in particular to be high enough to reduce a reliable reduction of stress during the construction of the component and thereafter, and at the same time to prevent precipitation or formation of the gamma prime phase, which, after all, would be detrimental to a structural result or welding result during component manufacturing.

In one embodiment, the aselective heating is effected at a temperature of just below a sintering temperature of the material. This embodiment is advantageously consistent with the above-described embodiment and additionally prevents the incipient sintering of material which is not used for the manufactured component and would possibly need to be removed again in a complex manner from cavities or from supporting structures of the component—in sintered form. Remaining below the sintering temperature normally also reliably ensures that the precipitation of a gamma prime phase does not occur.

In one embodiment, the aselective heating is effected by an inductive heating of a building chamber, e.g. of a corresponding additive manufacturing installation, by a radiant heating facility, such as, for example, a laser array, an array of laser diodes, an infrared emitter, or by way of a heating of a build platform.

In one embodiment, the aselective heating is carried out for preheating the layer. In accordance with this embodiment, the aselective heating can be carried out before, but of course additionally simultaneously also with, the step of selective irradiation.

In one embodiment, the aselective heating is carried out simultaneously with the selective irradiation of the layer.

As described above, the aselective heating allows the reliable prevention of macrocracks and advantageously brings about a reduction of stress in the material or in the melted material.

In one embodiment, the material constitutes an alloy which is difficult to weld, in particular a γ′-hardening nickel- or cobalt-based superalloy.

In one embodiment, the (finished) manufactured component is subjected to a thermal aftertreatment. This aftertreatment is preferably provided in order to bring about an (additional) stress relaxation and/or to instigate a precipitation hardening through segregation or formation of the gamma prime phase. The advantages according to the invention are manifested potentially even without a thermal aftertreatment, but may arise to a particularly advantageous extent if such a thermal aftertreatment is carried out.

In one embodiment, the first energy beam and the second energy beam are directed at or focused on the layer via a common optical unit or optical element. In the case of electron beams of the first energy beam and of the second energy beam, the optical unit mentioned can also be an electron optical unit.

In one embodiment, the melting laser and the further laser are fed to the common optical unit via a beam splitter or semi-transparent mirror.

This (these) embodiment(s) advantageously allow(s) a particularly simple beam guidance for the selective irradiation or a particularly reliable or reliably synchronous selective irradiation with the first energy beam and the second energy beam.

A further aspect of the present invention relates to an apparatus for the powder bed-based additive manufacturing of a component, which apparatus has a build platform, and also a coating device, a melting laser, a further laser and a common optical unit for the melting laser and the further laser, as described above, and wherein the apparatus furthermore comprises a device for the aselective heating of the layer, in particular a device for the inductive heating of a building chamber and/or a radiant heating facility, preferably an infrared emitter. A particular advantage of the apparatus described is that this apparatus or installation technology, in contrast to high global preheating temperatures, does not require significant adaptations of the hardware concept in the build space. Even a retrofitting possibility for already existing powder bed-based manufacturing installations or SLM installations is thus advantageously conceivable.

Embodiments, features and/or advantages which in the present case are described in association with the method may furthermore relate to the apparatus, and vice versa.

The expression “and/or” used here, when it is employed in a series of two or more elements, means that each of the elements mentioned can be used by itself, or any combination of two or more of the elements mentioned can be used.

Further details of the invention are described below with reference to the figures.

### BRIEF DESCRIPTION OF THE DRAWINGS

FIG. 1 shows a schematic side view of an apparatus in accordance with one embodiment of the present invention;

FIG. 2 indicates a schematic plan view of two laser beams which are generated using the apparatus illustrated in FIG. 1 and

FIG. 3 schematically indicates beam intensities of the laser beams illustrated in FIG. 2.

### DETAILED DESCRIPTION OF INVENTION

In the exemplary embodiments and figures, identical or identically acting elements may each be provided with the same reference signs. The illustrated elements and their size relationships among one another should not be regarded as true to scale, in principle; rather, individual elements may be illustrated with exaggerated thickness or size dimension in order to enable better illustration and/or in order to afford a better understanding.

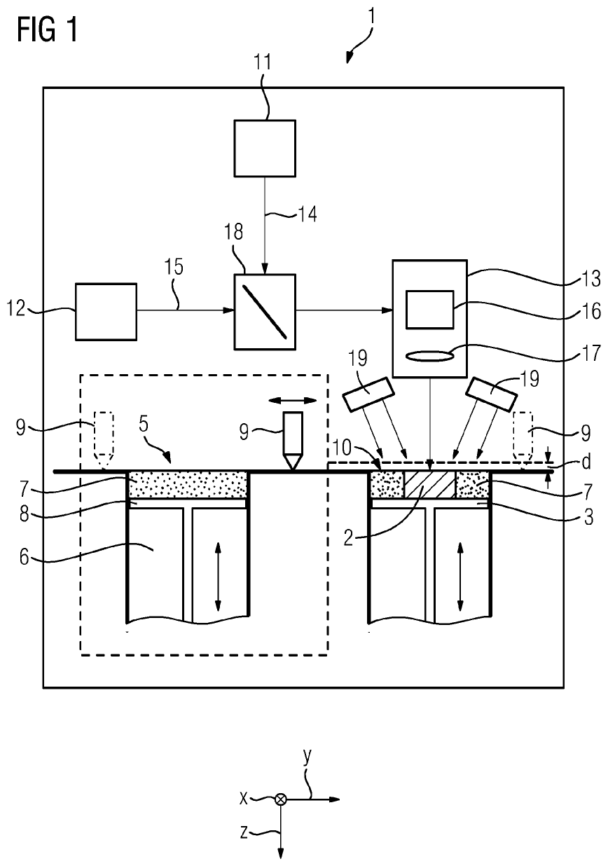

FIG. 1 shows an apparatus 1 in accordance with one embodiment of the present invention, which serves for the powder bed-based additive manufacturing of a component 2 or of a component portion; in particular for selective laser sintering, selective laser melting or electron beam melting.

The component 2 can be a component of a turbomachine, for example a component for the hot gas path of a gas turbine. In particular, the component can denote a rotor blade or guide vane, a ring segment, a burner part or a burner tip, a shroud, a screen, a heat shield, a nozzle, a seal, a filter, an orifice or lance, a resonator, a piston or a swirler, or a corresponding transition, insert, or a corresponding retrofit part. Alternatively, the component can denote some other component, in particular a component for applications in aeronautics or in automobility.

The apparatus 1 comprises a build platform 3, which is movable, in particular lowerable, in a vertical z-direction up and down within a building chamber 4. Furthermore, a powder supply 5 is provided. The latter comprises a powder chamber 6 for accommodating pulverulent material 7, a powder feed piston 8, which is movable in the z-direction up and down within the powder chamber 6, and a coating device with a squeegee 9, which is movable back and forth in the y-direction and designed to transport material 7 contained in the powder chamber 6 to the building chamber 4 and to distribute it uniformly with a predetermined layer thickness (cf. reference sign d) in the region of a construction zone of the building chamber 4.

Furthermore, the apparatus 1 has a first beam source, preferably a melting laser 11, and a second beam source, for example a further, second, laser 12. Furthermore, the apparatus 1 has a common optical unit or optical element 13 for the first beam source or the first beam 11 and the second beam source or the second beam 12.

The first beam source (first energy beam) and the second beam source (second energy beam) are preferably in each case lasers or laser beams, in particular such lasers which emit laser beams 14 and 15 having wavelengths in the infrared range, such as, for example, Nd-Yag- or CO₂ lasers or the like (cf. SLM). Alternatively, the aforementioned beam sources/beams can also be particle radiation, such as electron beams (cf. EBM).

The optical unit or optical element 13 comprises a scanner 16 and an F-theta lens 17. Arranged between the first energy beam 11 and the second energy beam 12 and the optical element 13 is a semi-transparent mirror or beam splitter 18, which directs the laser beam 14 of the first energy beam 11 and of the second energy beam 15 of the preheating laser 12 jointly to the optical element 13, from where the energy beams are directed at the construction zone via the scanner 16 and the F-theta lens 17—on the basis of layer information of a component layer 10 to be manufactured, which information is normally generated using software by means of computer-aided modeling from a CAD file.

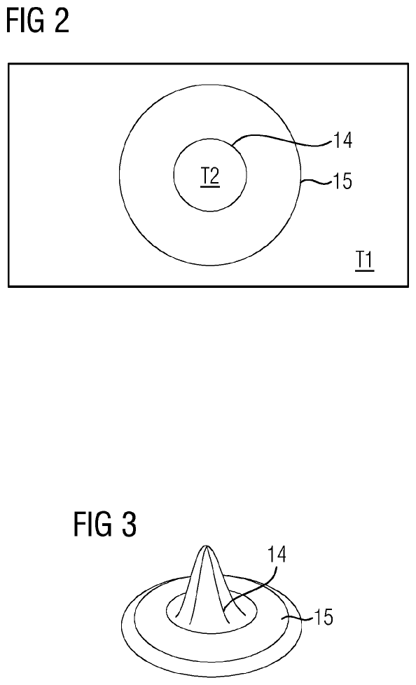

In order to manufacture a component 2 or a component portion using the apparatus 1, in a first step the build platform 3 is moved into a position which lies below the construction by an amount corresponding to the layer thickness d of the component layer 10 that is subsequently to be generated, wherein the layer thickness d normally lies in a range of between 10 and 100 μm, in particular between 20 and 40 μm. The powder feed piston 8 is positioned above the construction zone by an analogous amount. Afterward, the squeegee 9, proceeding from the position illustrated by dashed lines at the far left in FIG. 1, is moved into the far right position, likewise illustrated in a dashed manner, with the result that a layer 10 of the pulverulent component material 7 is distributed uniformly on the component platform 3. Subsequently, this layer 10 is locally melted and solidified in the region of the construction zone. For this purpose, the beams 14 and 15 are directed at the beam splitter 18 in such a way that the cross-sectionally circular laser beam or laser focus 14 of the processing laser 11 is surrounded ring-shapedly by the laser beam 15 of the preheating laser 12 or the focus thereof, as is illustrated schematically in FIG. 2. In the present case, this is achieved by operating the processing laser 11 in the Gaussian mode and the preheating laser 12 in the “donut mode” or “bagel mode”.

In this case, the radiation intensity of the laser beam 14 of the melting laser 11 is preferably significantly higher than that of the laser beam 15 of the further laser 12, as is shown schematically in the perspective illustration in FIG. 3.

The further laser beam 15 preferably brings about selective or local heating, in particular preheating, of each layer 10 to a temperature of at least 400° C., preferably of at least 500° C. During the construction of the component 2, a heat input of the further laser beam 15 is expediently superposed with a heat input of the laser beam 14 of the melting laser 11, such that the melting point of the material 7 can expediently be exceeded and the structure for the component can be solidified.

The laser beams 14 and 15, proceeding from the beam splitter 18, are directed jointly to the optical element 13, from where they are directed at the construction zone via the scanner 16 and the lens 17. In this case, the joint movement of the laser beams 14 and 15 relative to the construction zone is controlled (selectively) depending on layer information of the component layer 10 to be manufactured in each case.

Thanks to the ring-shaped arrangement of the laser beam 15 of the preheating laser 12 around the laser beam 14 of the processing laser 11, the laser beam 15 subjects the powder that is ultimately to be melted by the laser beam 14 to not only preheating but in part also post-heating, since the laser beam 15 both leads and lags behind the laser beam 14. Accordingly, high temperature gradients during the melting and thus hot cracking are effectively counteracted, wherein the radiation intensities of the laser beams 14 and 15 can be chosen independently of one another and can thus be optimally adapted to the component material 7 to be processed, the layer thickness d to be produced, and to the aselective, large-area or global heating described below.

Consequently, even the processing of component materials which are difficult to weld or hitherto have been scarcely weldable or not weldable at all is possible, such as the processing of a γ′-hardening nickel-base superalloy, in particular with a high proportion of γ′-precipitates, to mention just one example. In order to produce the next and succeeding layers, the component platform 3 is in each case lowered once again by a layer thickness d, and pulverulent component material 7 is applied and selectively melted.

One major advantage of the method according to the invention consists, firstly, in the above-described avoidance of hot cracking thanks to the flexibly adjustable and also local preheating and controlled cooling of the powder to be melted or the melted powder. Secondly, however, the equipment set-up is also simple since the melting laser 11 and the further laser 12 jointly utilize the optical element 13 and likewise the beam splitter 18, which results in comparatively low costs and a small space requirement. Furthermore, the coordination of the movements of the laser beams 14 and 15 is also unproblematic since the control of the movements can also always be effected jointly by way of the optical element 13.

The apparatus 1 furthermore has a device 19 for the aselective heating of each layer 10. The aforementioned device can concern—as illustrated—a radiant heating facility, such as an infrared emitter or a laser (diode) array. Alternatively, the device 19 can involve an inductive heating of the building chamber 4 or, unlike the illustration in FIG. 1, a heating of the build platform 3. Heat that can be input in each layer 10 by the device 19 (indicated by the arrows in the present case) preferably heats a large portion of the layer 10 in order (as described above) to prevent macrocracks during the manufacture of the component 2 as a whole in interaction with the synchronous selective irradiation according to the invention.

In FIG. 2, the frame around the laser foci of the beams 14 and 15 indicates that the present invention advantageously implements an aselective or global heating of a large portion of the layer 10 or the layer surface thereof at a temperature T1. In accordance with the present invention, the temperature T1 is chosen in such a way that it corresponds to at least one quarter of the temperature T2 which the respective layer 10 experiences as a result of the selective irradiation.

Expediently, the temperature T2 is locally at least just above a sintering or solidus temperature. Preferably, the temperature T2 is at least just above a melting point of the material 7.

Alternatively, for example, the layer 10 can be aselectively heated to a temperature of at least one third or even just below half of the temperature T2.

By way of example, the aselective heating can be effected at a temperature T1 of between 400° C. and 500° C.

Alternatively or additionally, the aselective heating is effected at a temperature of between 50° C. and 100° C. below an initial temperature for the formation of phase precipitates, in particular for the formation of a gamma prime phase (γ/γ′ solvus temperature) of the material 7.

Furthermore alternatively or additionally, the aselective heating of the large portion of the layer 10 is preferably effected below a sintering temperature of the material 7.

Furthermore, the aselective heating is advantageously effected for preheating the layer 10 and/or simultaneously with the selective irradiation of the layer 10, as described above.

The completed component 2 can furthermore be subjected to a thermal aftertreatment in order to bring about for example a stress relaxation and/or precipitation or segregation of alloying elements, such as carbides, nitrides or intermetallic phases, for the purpose of hardening (γ′ precipitation). Such a heat treatment can comprise a so-called solution heat treatment and one or more subsequent “ripening steps” with in each case a specifically set heating rate, holding time and cooling rate.

Furthermore, it is possible to use a so-called “HIP” process (“hot isostatic pressing”), i.e. the use of isostatic mechanical pressure after the additive construction of the component 2 and/or the thermal aftertreatment.

1. A method for powder bed-based additive manufacturing of a component, comprising:
selective irradiation of a layer composed of a pulverulent material with a first energy beam and a second energy beam, different than the first energy beam, wherein the second energy beam surrounds the first energy beam in a ring-shape, and
aselective heating of the layer, wherein a large portion of the layer is heated to a temperature of at least one quarter of the temperature which the layer experiences as a result of the selective irradiation.

2. The method as claimed in claim 1,
wherein the first energy beam comprises a melting laser and the second energy beam comprises a further laser beam, having a lower radiation intensity than the melting laser.

3. The method as claimed in claim 2,
wherein the further laser beam brings about a local heating of the layer to a temperature of above 500° C.

4. The method as claimed in claim 1,
wherein the aselective heating is effected at a temperature of between 400° C. and 500° C. and/or between 50° C. and 100° C. below an initial temperature for formation of phase precipitates.

5. The method as claimed in claim 1,
wherein the aselective heating is effected below a sintering temperature of the pulverulent material.

6. The method as claimed in claim 1,
wherein the aselective heating is effected by an inductive heating of a building chamber, a radiant heating facility, an infrared emitter, or by way of a heating of a build platform.

7. The method as claimed in claim 1,
wherein the aselective heating is carried out for a purpose of preheating the layer.

8. The method as claimed in claim 1,
wherein the aselective heating is carried out simultaneously with the selective irradiation of the layer.

9. The method as claimed in claim 1,
wherein the pulverulent material constitutes an alloy which is difficult to weld.

10. The method as claimed in claim 1,
wherein the manufactured component is subjected to a thermal aftertreatment.

11. The method as claimed in claim 1,
wherein the first energy beam and the second energy beam are directed at the layer via a common optical unit.

12. The method as claimed in claim 2,
wherein the melting laser and the further laser beam are fed to a common optical unit via a semi-transparent beam splitter.

13. An apparatus for powder bed-based additive manufacturing of a component, which apparatus is configured for carrying out a method as claimed in claim 1, comprising:
a build platform, a coating device, a melting laser, a further laser, and a common optical unit for the melting laser and the further laser, and
a device for the aselective heating of the layer.

14. The method as claimed in claim 3,
wherein the local heating comprises preheating.

15. The method as claimed in claim 4,
wherein the aselective heating is effected for formation of a gamma prime phase of the pulverulent material.

16. The method as claimed in claim 9,
wherein the alloy comprises a γ′-hardening nickel- or cobalt-based superalloy.

17. The apparatus as claimed in claim 13,
wherein the device for the aselective heating of the layer comprises a device for inductive heating of a building chamber, a radiant heating facility, or an infrared emitter.
